(19) United States
(12) Patent Application Publication
(10) Pub. No.: US 2009/0312138 A1
(43) Pub. Date: Dec. 17, 2009

(54) TRANSMISSION WITH AT LEAST TWO PLANET GEAR STAGES

(75) Inventors: Dietmar Illerhaus, Lindau (DE); Klaus Muller, Meckenbeuren (DE); Gert Hanker, Meckenbeuren (DE); Michael Obergasser, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/307,334

(22) PCT Filed: Jun. 29, 2007
(86) PCT No.: PCT/EP07/56544

§ 371 Date: Jan. 2, 2009

(30) Foreign Application Priority Data
Jul. 22, 2006 (DE) 10 2006 033 983.5

(51) Int. Cl. F16H 3/62; F16H 3/44

(52) U.S. Cl. 475/269; 475/275

(57) ABSTRACT

A transmission with a housing, a drive input shaft, a drive output shaft and at least two planetary gear sets for transmitting rotation from the drive input shaft to the drive output shaft. The planetary gear sets each include a sun gear, a ring gear and a planetary gear carrier. At least two clutches enable connecting the drive input shaft to one of the elements of the planetary gear sets, while the ring gears can be connected to the housing with the help of further clutch devices. The bearings of the transmission are arranged in the axial direction one behind another in such manner that axial forces acting on the elements of the planetary gear stages can be transmitted, via the bearings, to the housing.

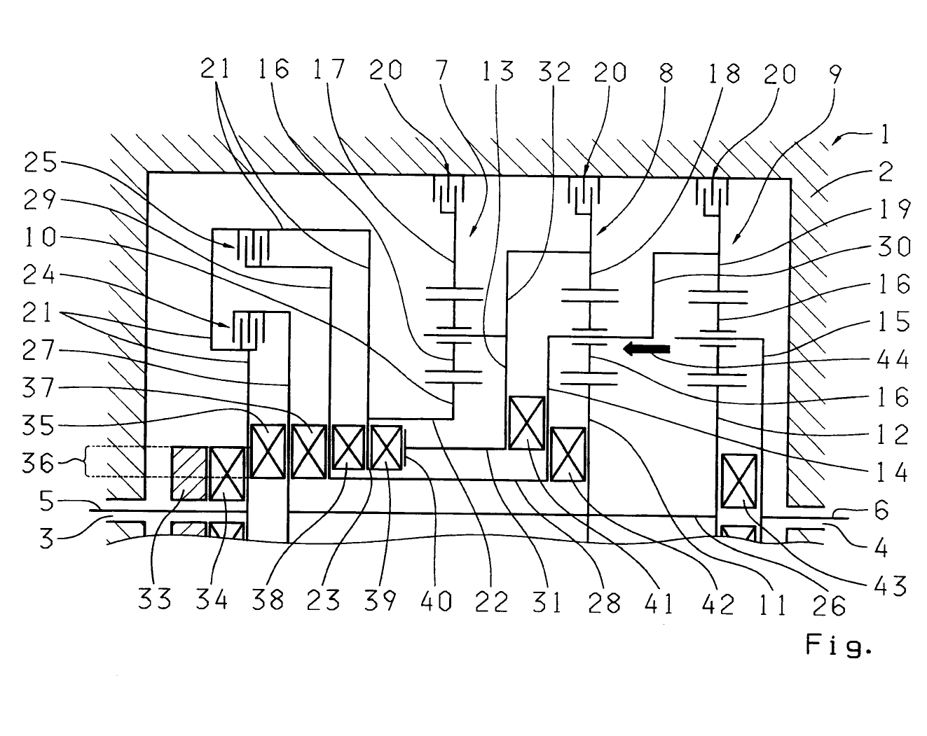

This application is a national stage completion of PCT/EP2007/056544 filed Jun. 29, 2007, which claims priority from German Application Serial No. 10 2006 033 983.5 filed Jul. 22, 2006.

### FIELD OF THE INVENTION

The present invention concerns a transmission with a housing, a drive input shaft and at least two planetary gear sets for transmitting rotation from the drive input shaft to the drive output shaft, the planetary gear sets comprising in each case the elements of a sun gear, a ring gear and a planetary gear carrier and at least two shiftable clutch devices for connecting the drive input shaft with one of the elements of the planetary gear sets, whereas the ring gears can be connected to the housing with the help of further shiftable clutch devices.

### BACKGROUND OF THE INVENTION

From the prior art transmissions, in particular automatic transmissions are known, which have a drive input shaft, a drive output shaft and a plurality of planetary gear sets for transmitting rotation from the drive input shaft to the drive output shaft. For example, DE 27 21 719 A1 describes a transmission with three or more gear sets. To be able to connect the drive input shaft to an element of the planetary gear sets such as the ring gear, the planetary gear carrier or the sun gear, a clutch drum with two shift clutches is provided. In the axial direction the two shift clutches are arranged one behind the other in the clutch drum. The ring gears of the planetary gear sets can be fixed relative to the housing of the transmission by means of shift brakes. The corresponding transmission gears can be engaged or selected by shifting the shift clutches and shift brakes.

The known system on the one hand suffers the disadvantage that the transmission is quite long in the axial direction, which makes it difficult to use the transmission in vehicle types which cannot provide sufficient structural space in the axial direction. On the other hand shifting of the transmission causes axial forces to act upon the individual elements of the planetary gear sets, which result in high loading of the elements themselves and of other parts of the transmission.

Thus, the purpose of the present invention is to provide a transmission that enables suitable dissipation of the axial forces acting upon the elements of the planetary gearsets in order to reduce the loading of transmission components, and which takes up less structural space in the axial direction.

### SUMMARY OF THE INVENTION

The transmission according to the invention, preferably an automatic transmission, comprises a housing, a drive input shaft and a drive output shaft. Further, at least two planetary gear sets are provided for transmitting rotation from the drive input shaft to the drive output shaft. Each planetary gear set comprises the elements of a sun gear, a ring gear and a planetary gear carrier, and at least two shiftable clutch devices are provided for connecting the drive input shaft with one of the elements of the planetary gear sets. With the help of further shiftable clutch devices the ring gears can be connected to the housing. The bearings of the transmission arranged in the axial direction are positioned one behind another in such manner that the axial forces acting on the elements of the planetary gear stages can be transferred via the bearings to the housing. Thus, the bearings form, as it were, a transfer chain.

Accordingly, the invention has the advantage that axial forces acting on the elements of the planetary gearsets during shift processes are in a simple way transferred via the bearings to the housing, so that the loading of other parts of the transmission is reduced.

In a preferred embodiment of the transmission according to the invention, the bearings adjacent to one another overlap at least partially as regarded in the axial direction. In this way direct and rectilinear force transfer through the bearings is achieved without the occurrence of large torques.

In a particularly preferable embodiment of the transmission according to the invention, the shiftable clutch devices for connecting the drive input shaft to one of the elements of the planetary gear sets are arranged one behind another in the radial direction. This provides a transmission whose length in the axial direction is particularly short.

In an advantageous embodiment of the transmission according to the invention, a first and a second clutch for connecting the drive output shaft to one of the elements of the planetary gear sets are provided, and in addition, first, second and third planetary gear sets are provided. The planetary gear sets can for example be arranged in the sequence between the drive input shaft on one side and the drive output shaft on the other side.

In a further advantageous embodiment of the transmission according to the invention, the drive input shaft is connected in a rotationally fixed manner by means of a first, radially outward-extending connection element, to a first sun gear shaft on which the sun gear of the first planetary gear sets is arranged.

In another advantageous embodiment of the transmission according to the invention, the first and the second clutch devices are arranged on the first connection element. The first connection element can for example be formed in the manner of a clutch drum.

According to a further advantageous embodiment of the transmission according to the invention, the sun gears of the second and third planetary gear sets are arranged in a rotationally fixed manner on a common second sun gear shaft, and a second radially outward-extending connection element is arranged on the second sun gear shaft, which can be connected to the drive input shaft by means of the first clutch device.

In a further advantageous embodiment of the transmission according to the invention, the planetary gear carrier of the second planetary gear set is arranged on a first auxiliary shaft and a radially outward-extending third connection element is arranged on the first auxiliary shaft, which can be connected to the drive input shaft by means of the second clutch device.

In another advantageous embodiment of the transmission according to the invention, the planetary gear carrier of the second planetary gear set is connected in a rotationally fixed manner to the ring gear of the third planetary gear set by means of a fourth connection element.

According to a further advantageous embodiment of the transmission according to the invention, the planetary gear carrier of the first planetary gear set is arranged on a second auxiliary shaft and connected in a rotationally fixed manner to the ring gear of the second planetary gear set by means of a fifth connection element.

In a further preferred embodiment of the transmission according to the invention, an abutment element that projects radially inward is provided on the first connection element. This abutment element, which can for example be in the form of an all-round ring, can serve for example as an end-stop for a bearing.

In another advantageous embodiment of the transmission according to the invention, a first bearing is arranged, as viewed in the axial direction, between an abutment on the housing and the first connection element. This abutment too can for example be in the form of an all-round ring arranged fixed on the housing.

In a further preferred embodiment of the transmission according to the invention, a second bearing is arranged, as viewed in the axial direction, between the first connection element and the second connection element.

According to a further advantageous embodiment of the transmission according to the invention, a third bearing is arranged, as viewed in the axial direction, between the second and the third bearing components.

In another advantageous embodiment of the transmission according to the invention, a fourth bearing is arranged, as viewed in the axial direction, between the third connection element and the abutment.

In a further, particularly preferred embodiment of the transmission according to the invention, a fifth bearing is arranged, as viewed in the axial direction, between the abutment and the end of the second auxiliary shaft. In this way the axial forces acting on the second auxiliary shaft can be transferred to the fifth bearing.

In another advantageous embodiment of the transmission according to the invention, a sixth bearing is arranged, as viewed in the axial direction, between the planetary gear carrier of the first planetary gear set and the planetary gear carrier of the second planetary gear set.

According to a further advantageous embodiment of the transmission according to the invention, a seventh bearing is arranged, as viewed in the axial direction, between the planetary gear carrier of the second planetary gear set and the sun gear of the second planetary gear set.

In another advantageous embodiment of the transmission according to the invention, an eighth bearing is arranged, as viewed in the axial direction, between the sun gear of the third planetary gear set and the planetary gear carrier of the third planetary gear set.

In a further preferred embodiment of the transmission according to the invention, the planetary gear carrier of the third planetary gear set is connected to the drive output shaft.

### BRIEF DESCRIPTION OF THE INVENTION

Below, the invention is explained in greater detail with reference to an example embodiment and to the associated drawing. The single FIGURE shows a schematic side view of the upper half of an embodiment of the transmission according to the invention.

### DETAILED DESCRIPTION OF THE INVENTION

The automatic transmission 1 illustrated comprises a housing 2 which essentially encloses the transmission, a first opening 3 being provided on one side and a second opening 4 on the opposite side. The transmission 1 further comprises a drive input shaft 5 which extends into the housing 2 through the first opening 3, while a drive output shaft 6 extends out of the housing 2 through the second opening 4. The drive input shaft 5 and the drive output shaft 6 are arranged coaxially, one behind the other.

Inside the housing 2 between the drive input and drive output shafts 5, 6 are provided, in addition, a first planetary gear set 7, a second planetary gear set 8 and a third planetary gear set 9 for transmitting rotation of the drive input shaft 5 to the drive output shaft 6. The planetary gear sets 7, 8, 9 each comprise respective sun gears 10, 11, 12, planetary gear carriers 13, 14, 15 on which a plurality of planetary gears 16 are arranged, and ring gears 17, 18, 19. The planetary gear carrier 15 of the third planetary gear set 9 is connected in a rotationally fixed manner to the drive output shaft 6. On the inside wall of the housing 2 are provided shiftable clutch devices 20, with the help of which the ring gears 17, 18, 19 can be connected on their side facing away from the respective sun gears 10, 11, 12, to the housing 2 in order to fix the ring gears 17, 18, 19 with respect to the housing 2 when in the corresponding shift position.

Inside the housing 2 a first connection element 21 is provided on the drive input shaft 5. The connection element 21 first extends radially outward and then turns radially inward again, and is connected in a rotationally fixed manner to a first sun gear shaft 22 on which the sun gear 10 of the first planetary gear set 7 is arranged. The first sun gear shaft 22 is arranged coaxially with the drive input and drive output shafts 5, 6. Starting from the end of the first connection element 21 that faces toward the first sun gear shaft 22 an abutment component 23 also extends radially inward, the significance of which will be explained later. In addition, on the first connection element 21 are provided a first shiftable clutch device 24 and a second shiftable clutch device 25 for connecting the drive input shaft 5 to one of the elements of the planetary gear sets 7, 8, 9. The first clutch device 24 and the second clutch device 25 are arranged one behind the other in the radial direction, which reduces the length of the transmission 1 in the axial direction.

The sun gears 11, 12 of the second and third planetary gear stages 8, 9 are arranged in a rotationally fixed manner on a common, second sun gear shaft 26, which is coaxial with the drive input and output shafts 5, 6 and the first sun gear shaft 22. At its end facing toward the drive input shaft 5 this second sun gear shaft 26 has a radially outward-extending, second connection element 27 which can be connected to the drive output shaft 5 by means of the first clutch device 24.

The planetary gear carrier 14 of the second planetary gear set 8 is arranged on a first auxiliary shaft 28. On the end of this first auxiliary shaft 28 facing toward the drive input shaft 5, the shaft 28 also being coaxial with the drive input and output shafts 5, 6, is arranged a third, radially outward-extending connection element 29 which can be connected to the drive output shaft 5 by the second clutch device 25. Furthermore, the planetary gear carrier 14 of the second planetary gear set 8 is connected in a rotationally fixed manner by a fourth connection element 30 to the ring gear 19 of the third planetary gear set 9. Moreover, the planetary gear carrier 13 of the first planetary gear set 7 is arranged on a second auxiliary shaft 31 and connected in a rotationally fixed manner by a fifth connection element 32 to the ring gear 18 of the second planetary gear set 8.

The housing 2 has an all-round abutment 33 in the area of the first opening 3, so that the drive input shaft 5 extends through the abutment 33. Between the side of the abutment 33 facing away from the opening 3 and the first connection element 21 in the axial direction is arranged a first bearing 34. Thus, any axial forces acting on the first connection element 21 can be transferred to the housing 2 via the first bearing 34 and the abutment 33.

In the direction toward the drive output shaft 6 a second bearing 35 is provided behind the first bearing 34. This second bearing 35 is arranged in the axial direction between the first connection element 21 and the second connection element 27. The accordingly adjacent bearings 34, 35 are designed such that they overlap, at least partially, as viewed in the axial direction. In the FIGURE this is indicated by the overlap zone 36. A similar overlap exists between all the bearings said to be adjacent to one another in what follows.

A third bearing 37 is arranged adjacent to the second bearing 35, as viewed in the axial direction between the second and the third connection elements 27 and 29. A fourth bearing 38 is arranged adjacent to the third bearing 37 in the axial direction between the third connection element 29 and the abutment component 23 on the first connection element 21. A fifth bearing 39 is arranged adjacent to the fourth bearing 38 in the axial direction between the abutment component 23 and an end 40 of the second auxiliary shaft 31. Furthermore, a sixth bearing 41 is arranged adjacent to the fifth bearing 39 in the axial direction between the planetary gear carrier 13 of the first planetary gear set 7 and the planetary gear carrier 14 of the second planetary gear set 8. In addition, a seventh bearing 42 is arranged adjacent to the sixth bearing 41 in the axial direction between the planetary gear carrier 14 of the second planetary gear set 8 and the sun gear 11 of the second planetary gear stage 8. Moreover, an eighth bearing 43 is arranged adjacent to the seventh bearing 42 in the axial direction between the sun gear 12 of the third planetary gear set 9 and the planetary gear carrier 15 of the third planetary gear set 9.

The bearings 34, 35, 37, 38, 39, 41, 42, 43 are arranged one after another in such manner that axial forces acting on the respective element of the planetary gear sets 7, 8, 9 can simply be transferred to the housing 2, as described below with reference to an example. For example, if an axial force 44 acts upon the planetary gears 16 of the planetary gear carrier 14 of the second planetary gear set 8, this force is transmitted to the abutment 33 and so to the housing 2 via the planetary gear carrier 14, the sixth bearing 41, the auxiliary shaft 31, the fifth bearing 39, the abutment 23, the fourth bearing 38, the third connection element 29, the third bearing 37, the second connection element 22, the second bearing 35, the first connection element 21 and the first bearing 34.

### INDEXES

1 Automatic transmission
2 Housing
3 First opening
4 Second opening
5 Drive input shaft
6 Drive output shaft
7 First planetary gear set
8 Second planetary gear set
9 Third planetary gear set
10 Sun gear
11 Sun gear
12 Sun gear
13 Planetary gear carrier
14 Planetary gear carrier
15 Planetary gear carrier
16 Planetary gears
17 Ring gear
18 Ring gear
19 Ring gear
20 Clutch device
21 First connection element
22 First sun gear shaft
23 Abutment component
24 First clutch device
25 Second clutch device
26 Second sun gear shaft
27 Second connection element
28 First auxiliary shaft
29 Third connection element
30 Fourth connection element
31 Second auxiliary shaft
32 Fifth connection element
33 Abutment
34 First bearing
35 Second bearing
36 Overlap zone
37 Third bearing
38 Fourth bearing
39 Fifth bearing
40 End (of shaft)
41 Sixth bearing
42 Seventh bearing
43 Eighth bearing
44 Axial force

1-20. (canceled)

21. A transmission comprising a housing (2), a drive input shaft (5), a drive output shaft (6) and at least two planetary gear sets (7, 8, 9) for transmitting rotation from the drive input shaft (5) to the drive output shaft (6), each of the planetary gear sets (7, 8, 9) have a sun gear (10, 11, 12), a ring gear (17, 18, 19) and a planetary gear carrier (13, 14, 15), at least two shiftable clutch devices (24, 25) connect the drive input shaft (5) to one of the sun gear (10, 11, 12), the ring gear (17, 18, 19) and the planetary gear carrier (13, 14, 15) of the planetary gear sets (7, 8, 9), the ring gears (17, 18, 19) are connectable to the housing (2) with further shiftable clutch devices (20) and the drive input shaft (5) is connected in a rotationally fixed manner, via a radially outward-extending, first connection element (21), to a first sun gear shaft (22) on which the sun gear (10) of the first planetary gear set (7) is arranged, the transmission (1) comprises bearings (34, 35, 37, 38, 41, 42, 43) arranged in the axial direction one behind another in such a manner that axial forces acting on the sun gear (10, 11, 12), the ring gear (17, 18, 19) and the planetary gear carrier (13, 14, 15) of the planetary gear sets (7, 8, 9) are transmitted, via the bearings (34, 35, 37, 38, 39, 41, 42, 43), to the housing (2), and a radially inward-projecting abutment component (23) is provided on the first connection element (21), which is positioned between two bearings (38, 39) arranged in the axial direction.

22. The transmission according to claim 21, wherein the bearings (34, 35, 37, 38, 39, 41, 42, 43) that are adjacent to one another overlap at least partially, as viewed in an axial direction.

23. The transmission according to claim 21, wherein the at least two shiftable clutch devices (24, 25) for connecting the drive input shaft (5) to one of the elements of the planetary gear sets (7, 8, 9) are arranged one behind another in a radial direction.

24. The transmission according to claim 21, wherein a first clutch device (24) and a second clutch device (25) are arranged on the first connection element (21).

25. The transmission according to claim 21, wherein the sun gears (11, 12) of the second and the third planetary gear sets (8, 9) are arranged in a rotationally fixed manner on a common, second sun gear shaft (26), and the second sun gear shaft (26) also supports a radially outward-extending, second connection element (27) which is connected to the drive input shaft (5) by the first clutch device (24).

26. The transmission according to claim 21, wherein the planetary gear carrier (14) of the second planetary gear set (8) is arranged on a first auxiliary shaft (28), and the first auxiliary shaft (28) supports a radially outward-extending, third connection element (29) which is connected to the drive input shaft (5) by means of the second clutch device (25).

27. The transmission according to claim 26, wherein the planetary gear carrier (14) of the second planetary gear set (8) is connected in a rotationally fixed manner to the ring gear (19) of the third planetary gear set (9) via a fourth connection element (30).

28. The transmission according to claim 21, wherein the planetary gear carrier (13) of the first planetary gear set (7) is arranged on a second auxiliary shaft (31) and connected in a rotationally fixed manner to the ring gear (18) of the second planetary gear set (8) via a fifth connection element (32).

29. The transmission according to claim 21, wherein a first bearing (34) is arranged, in the axial direction, between an abutment (33) on the housing (2) and the first connection element (21).

30. The transmission according to claim 29, wherein a second bearing (35) is arranged, in the axial direction, between the first connection element (21) and a second connection element (27).

31. The transmission according to claim 30, wherein a third bearing (37) is arranged, in the axial direction, between the second connection element (27) and a third connection element (29).

32. The transmission according to claim 31, wherein a fourth bearing (38) is arranged, in the axial direction, between a third connection element (29) and the radially inward-projecting abutment component (23).

33. The transmission according to claim 32, wherein a fifth bearing (39) is arranged, in the axial direction, between the radially inward-projecting component (23) and an end (40) of the second auxiliary shaft (31).

34. The transmission according to claim 33, wherein a sixth bearing (41) is arranged, in the axial direction, between the planetary gear carrier (13) of the first planetary gear stage (7) and the planetary gear carrier (14) of the second planetary gear stage (8).

35. The transmission according to claim 34, wherein a seventh bearing (42) is arranged, in the axial direction, between the planetary gear carrier (14) of the second planetary gear set (8) and the sun gear (11) of the second planetary gear set (8).

36. The transmission according to claim 35, wherein an eighth bearing (43) is arranged, in the axial direction, between the sun gear (12) of the third planetary gear set (9) and the planetary gear carrier (15) of the third planetary gear set (9).

37. The transmission according to claim 21, wherein the planetary gear carrier (15) of the third planetary gear set (9) is connected to the drive output shaft (6).
